(19) United States
(12) Patent Application Publication
(10) Pub. No.: US 2015/0345759 A1
(43) Pub. Date: Dec. 3, 2015

(54) Adjustable Light Strip

(71) Applicant: Brian Gazlay, Wallingford, CT (US)

(72) Inventor: Brian Gazlay, Wallingford, CT (US)

(21) Appl. No.: 14/728,679

(22) Filed: Jun. 2, 2015

Related U.S. Application Data
(60) Provisional application No. 62/006,305, filed on Jun. 2, 2014.

(51) Int. Cl. F21V 21/08; F21S 4/00; F21V 23/06; F21V 23/04

(52) U.S. Cl. CPC F21V 21/08; F21V 23/04; F21S 4/005; F21V 23/06

(57) ABSTRACT

An adjustable light strip having multiple separable light units that can be secured to the interior of a bag or purse in order to illuminate the interior thereof. The adjustable light strip includes a control unit having a power source, a power switch for selectively illuminating the light units, and least one light, wherein the control unit is removably connected to one or more additional light units. Each light unit includes a housing enclosing an LED light and is removably connected to the control unit and/or additional light units. The light units are connected in a side-by-side fashion and can be separated to shorten the length of the light strip if so desired. The adjustable light strip includes an adhesive backing so that the light strip can be secured to the interior of a bag, purse, or other article in a desired position.

### CROSS REFERENCE TO RELATED APPLICATION

This application claims the benefit of U.S. Provisional Application No. 62/006,305 filed on Jun. 2, 2014. The above identified patent application is herein incorporated by reference in its entirety to provide continuity of disclosure.

### BACKGROUND OF THE INVENTION

1. Field of the Invention

The present invention relates to a light strip for illuminating the interior of a bag or purse among various other articles. More specifically, the present invention relates to an adjustable light strip having a plurality of light units that are removably connected to one another in a side-by-side orientation. The adjustable light strip includes an adhesive backing for securing the light strip to the interior of a bag or purse in a desired position.

People frequently search through purses, backpacks, briefcases and other types of bags and luggage in order to locate specific articles located therein. However, in low light conditions such as in a dark room or during the evening, the user may have difficulty locating objects within their bag and must fumble around in order to attempt to locate the desired item. If the user's bag contains various items, the user may have trouble finding a single item, which can be frustrating. Thus, a device that can be secured to a conventional bag to provide light to the interior thereof is desired.

Many people may use the light produced by their cell phone or other mobile device to illuminate the interior of a purse or bag, but this is inconvenient. Mobile devices are not adapted for use as flashlights and may not provide enough light for the user to be able to see the interior of the purse. Further, the user must hold the light in one hand and must then hold the bag and search through the bag with the other hand. Thus, the user may have difficulty simultaneously holding the light and searching through the bag at the same time.

2. Description of the Prior Art

Devices have been disclosed in the prior art that relate to purse lights. These include devices that have been patented and published in patent application publications. These devices generally relate to lighting devices that can be positioned in a purse or handbag for illuminating the contents thereof. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 4,912,611 to Lyle discloses a light for a purse or another type of a bag. The device includes a control switch having actuating arms that are adapted to cause a light to illuminate whenever the purse is opened. The light source and control switch have hook and loop fastening material thereon for securing the device to the interior of a purse. The light source is connected to the control switch by an elongated conductor. Thus, while Lyle discloses a light for use with a purse, Lyle fails to disclose an adjustable light strip having a plurality of removable light units and that includes an adhesive thereon for securing the light strip to a purse or handbag.

U.S. Pat. No. 6,824,291 to Vautrin et al. discloses a pocketbook light. The device includes a light source and an optically transmitting light pipe that brings light in close proximity to the contents of the pocketbook. A set of individual LEDs can be disposed along the bottom or sidewall of the pocketbook to provide additional illumination. Thus, Vautrin et al. does not disclose an adjustable light strip that can be adhesively secured to a conventional bag or purse and that includes separable light units.

U.S. Pat. No. 8,382,309 to Johnston discloses a light pod for illuminating the interior of a handbag or purse. The light pod includes a housing having LEDs therein. The LEDs are adapted to illuminate when the user touches the pod, and the housing may include a timer for adjusting the duration of illumination once the pod is touched. Thus, Johnston fails to disclose a light strip having a plurality of separable light units that can be secured to one another in a linear orientation and that are operated via a power switch on a control unit.

U.S. Pat. No. 5,934,790 to Quintana et al. discloses a purse lighting system. The lighting system is removably mountable within a purse and includes a control circuit with an illumination lamp. The lamp is activated for a predetermined period of time by closing a momentary contact switch in order to prevent accidental drainage of the light system power supply. Thus, Quintana discloses a purse light, but does not disclose an adjustable light strip with a plurality of light units that are removable therefrom.

U.S. Pat. No. 6,508,568 to Blue-Recio discloses a light assembly for a purse. The light assembly comprises a casing having an exterior wall at least partially formed by a transparent material. A circuit assembly having an illumination source, a power source, and a switch assembly is mounted within the interior of the casing. A mounting structure is secured to the exterior wall and can be permanently or removably connected to various positions on the interior of a purse. Therefore, Blue-Recio fails to disclose an adjustable light strip having a plurality of light units that are removable therefrom.

Finally, U.S. Published Patent Application Number 2012/0212940 to Leuty discloses a purse having a built-in light. The device includes a light source built into the bottom or side of a purse or similar article. Thus, the device includes a purse specially adapted to include a light therein, and does not disclose a light strip removably securable to a conventional purse via an adhesive thereon.

These prior art devices have several known drawbacks. Various devices in the prior art provide lights for use with purses or bags. However, many such devices include only a single illumination source and thus may not provide sufficient light for a user. Further, the prior art devices do not include a plurality of separable light units that allows the user to remove lights from the light strip depending upon the size and shape of the purse or bag. Moreover, some devices include lights permanently installed in a purse or bag, and thus do not provide light strips removably securable to a conventional purse or bag.

In light of the devices disclosed in the prior art, it is submitted that the present invention substantially diverges in design elements from the prior art and consequently it is clear that there is a need in the art for an improvement to existing purse light devices. In this regard the instant invention substantially fulfills these needs.

### SUMMARY OF THE INVENTION

In view of the foregoing disadvantages inherent in the known types of adjustable light strips now present in the prior art, the present invention provides a new adjustable light strip wherein the same can be utilized for providing convenience for the user when illuminating the interior of a conventional bag, purse, or similar article.

It is therefore an object of the present invention to provide a new and improved adjustable light strip device that has all of the advantages of the prior art and none of the disadvantages.

It is another object of the present invention to provide an adjustable light strip having a plurality of light units used to illuminate the interior of a purse or bag.

Another object of the present invention is to provide an adjustable light strip comprising a plurality of light units, wherein the user can remove or separate one or more of the light units in order to create a light strip of a desired size.

Yet another object of the present invention is to provide an adjustable light strip having an adhesive backing for securing the light strip to the interior of a bag or purse.

Another object of the present invention is to provide an adjustable light strip that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the adjustable light strip of the present invention.

FIG. 1B shows a perspective view of the underside of the adjustable light strip of the present invention.

FIG. 2A shows a perspective view of the light units of an embodiment of the present invention as positioned for securement.

FIG. 2B shows a perspective of the light units of another embodiment of the present invention as positioned for securement.

FIG. 3 shows a schematic diagram of the light units attached to the control unit of the present invention.

FIG. 4 shows a view of the adjustable light strip of the present invention as secured to a purse.

### DETAILED DESCRIPTION OF THE INVENTION

Reference is made herein to the attached drawings. Like reference numerals are used throughout the drawings to depict like or similar elements of the adjustable light strip. For the purposes of presenting a brief and clear description of the present invention, the preferred embodiment will be discussed as used for providing illumination in the interior of a purse or handbag. The figures are intended for representative purposes only and should not be considered to be limiting in any respect.

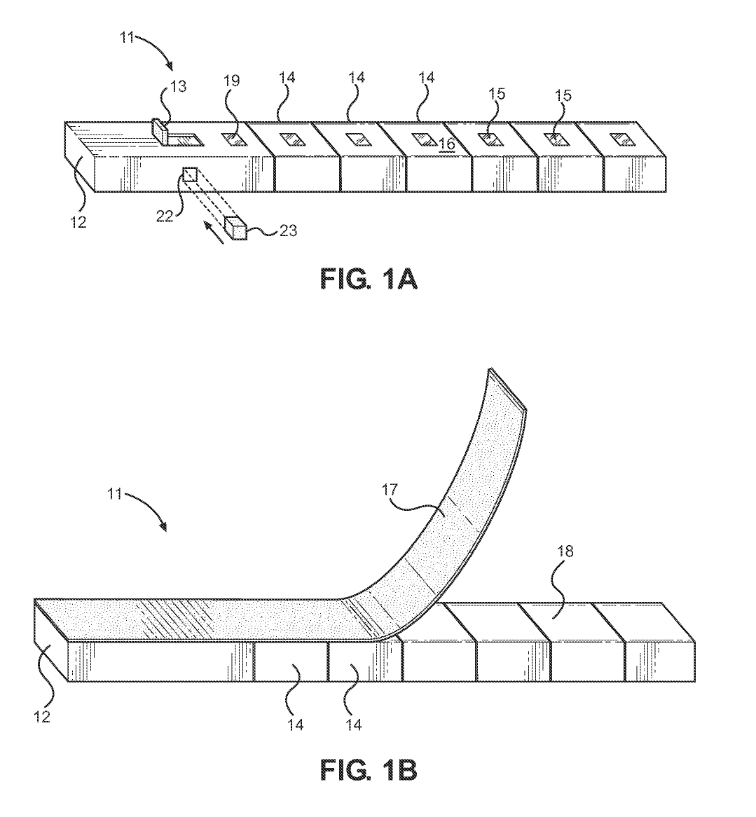

Referring now to FIGS. 1A and 1B, there are shown perspective views of the adjustable light strip of the present invention. The adjustable light strip 11 includes a control unit 12 and one or more light units 14 removably secured thereto. The control unit 12 comprises a compact housing that includes a power source, a power switch 13, and at least one light 19 thereon. The housing is preferably thin so as to not consume much space within the interior of a bag. The power switch 13 allows the user to turn the lights 19, 15 on or off. The control unit 12 housing is preferably substantially rectangular.

In some embodiments, the adjustable light strip 11 further includes a magnetically operated momentary switch 22. The momentary switch 22 operates in conjunction with a magnet 23 that can be removably engaged with the momentary switch 22. When the magnet 23 is engaged with the momentary switch 22, the electrical circuit within the device is broken, preventing the lights from illuminating. When the magnet 23 is disengaged from the momentary switch 22, the control circuit in the control unit 12 is completed and the lights are illuminated. It is noted that the power switch 13 must be in the “on” position so that the electrical circuit is completed, in order for the momentary switch 22 to function in the manner herein described. In this way, the adjustable light strip 11 can be secured to one side of a purse or bag, while the magnet can be secured on an opposite side thereof preferably via adhesives. The momentary switch 22 and the magnet 23 can then engage when the purse is closed such that the lights will not be illuminated, and when the purse is opened the momentary switch 22 and magnet 23 are separated, causing the lights to illuminate.

Each light unit 14 includes a housing that encloses a light 15 therein. The light 15 is preferably flush against the upper surface 16 of each light unit 14. Alternatively, the light 15 may shine through a window or lens disposed on the upper surface 16 of the housing. Each light 15 is preferably an LED light so as to provide high brightness with low power consumption. Each light unit 14 is substantially rectangular such that the light units 14 can be arranged flush against one another in a side-by-side or linear orientation. Thus, the adjustable light strip 11 comprises a generally rectangular shape when one or more light units 14 are secured to the control unit 12.

The lower surface 18 of each light unit 14 and of the control unit 12 includes an adhesive 18 thereon. The adhesive 18 is protected by a removable backing 17 that covers the adhesive 18 until it is desired to be used. In this way, the adjustable light strip 11 of the present invention can be secured to various support surfaces, such as the interior of a purse or bag. This allows the user to position the adjustable light strip 11 in a desired position within a bag in order to illuminate the same.

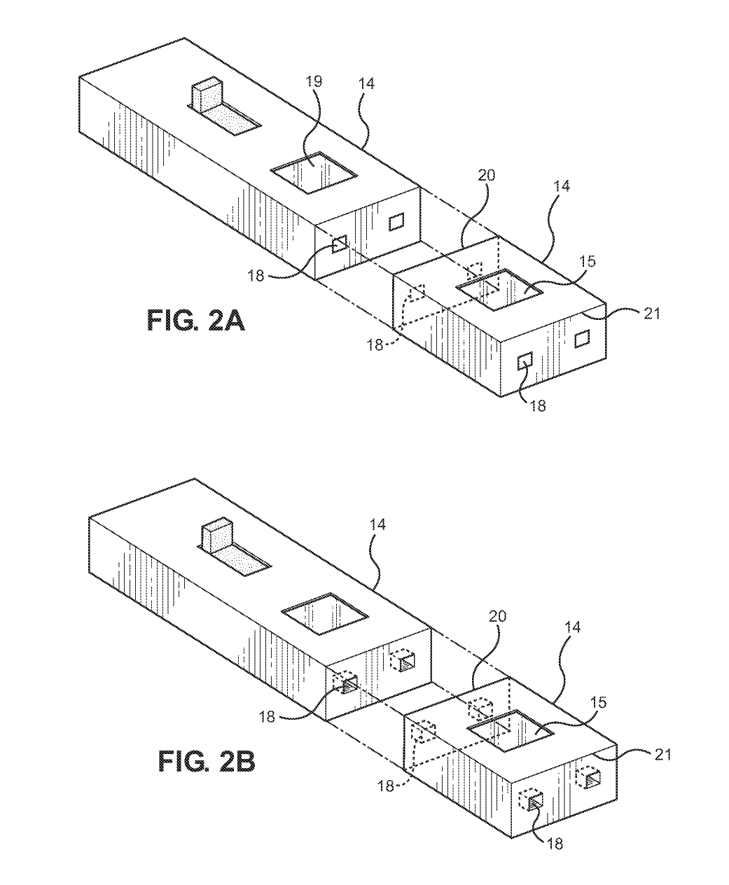

Referring now to FIG. 2A, there is shown a perspective view of an embodiment of the light units of the present invention as positioned for securement. The control unit 12 is connected to one or more removable light units 14. The light units 14 may be connected by a break away type connection wherein the light units 14 cannot again be secured to the control unit 12 or other light units 14 once removed. Alternatively, the control unit 12 may include removable connectors 18 on a first side thereof. Further, each light unit 14 includes one or more connectors 18 on a first side 20 thereof and one or more connectors 18 on a second side 21 thereof. The connectors 18 on the first side 20 of a light unit 14 can be placed in contact with the connectors 18 on the second side 21 of an adjacent light unit 14. This allows the electricity in the first light unit 14 to flow into the adjacent light unit 14 to power the light 15 therein. In this way, all of the light units 14 secured to one another are powered by the control unit 12.

Referring now to FIG. 2B, there is shown a perspective view of an alternate embodiment of the light units of the present invention as positioned for securement. In an alternate embodiment, the light units 14 may be secured together via mating fasteners thereon. Each light unit may include a fastener on a first side 20 thereof that can engage with a fastener on a second side 21 of an adjacent light unit 14. For example, the first side of a first light unit may include a male fastener thereon that can engage with a female fastener on the second side of a second light unit. Thus, a first side 20 of a light unit 14 may include protrusions adapted to be inserted into recessed areas on a second side 21 of a second light unit 14. Further, the control unit may include recessed areas thereon for receiving the protrusions on the first side 20 of a light unit 21. The recessed areas and protrusions may be centered on the connectors 18 so that the connectors can be easily secured to one another.

The user can separate one or more light units 14 from the adjustable light strip 11 to accommodate the size of the bag or purse in which the adjustable light strip 11 will be installed. The user may require an elongated adjustable light strip 11 to provide light in a large purse, and the user may wish to remove light units 14 so that the adjustable light strip 11 fits within a small purse or handbag. Thus, the adjustable light strip 11 can be used with any conventional handbag or purse regardless of the shape or size thereof.

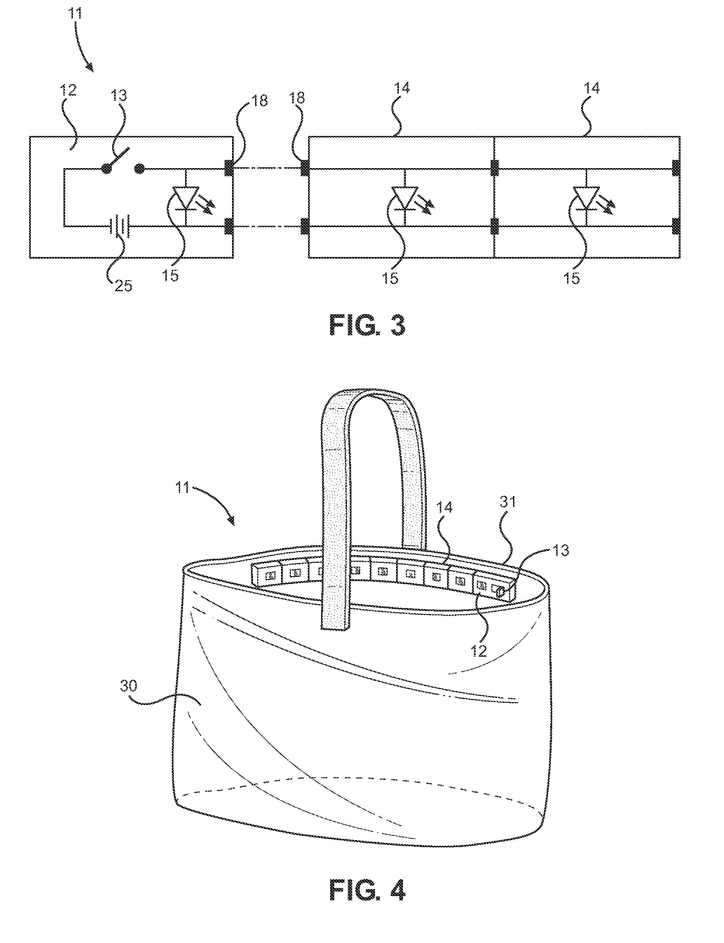

Referring now to FIG. 3, there is shown a schematic diagram of the light units attached to the control unit of the present invention. The control unit 12 includes a power source 25, such as one or more batteries, and includes a power switch 13 for selectively powering the one or more light units 14. The control unit 12 further includes at least one light 15 so that the adjustable light strip 11 always includes at least one light 15. The control unit 12 is electrically connected to a plurality of light units 14, wherein the light units 14 can be removed from the adjustable light strip 11 if so desired. Preferably, the lights 15 are electrically connected in parallel so that the lights may illuminate even if one or more lights 15 are broken or damaged. Thus, additional light units 14 can be added by engaging the connectors 18 on the light units as desired by the user.

Referring now to FIG. 4, there is shown a view of the adjustable light strip of the present invention as secured to a purse. The adjustable light strip 11 of the present invention can be secured to various surfaces and is particularly adapted to be secured to the interior of a bag, purse, backpack, suitcase, or various other article of luggage. The adhesive on the lower surface of the light strip can be secured to the interior wall or portion of a purse in a desired location in order to illuminate the interior of the purse. In the illustrated embodiment, the adjustable light strip 11 is positioned horizontally along the upper end 31 of the interior of the bag 30. In this way, the user can turn on the power switch 13 to illuminate the lights on each light unit 14 so that the light produced thereby can be directed towards the bottom of the interior of the bag. This allows the user to easily and clearly see the various items within the bag in low light.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An adjustable light strip, comprising:
a control unit comprising a power switch and at least one light, wherein said control unit is adapted to enclose a power source;
one or more light units removably connected to said control unit, wherein each of said one or more light units comprises a housing and a light.

2) The adjustable light strip of claim 1, wherein said one or more light units and said control unit are connected in a linear configuration.

3) The adjustable light strip of claim 1, wherein a lower surface of said control unit and a lower surface of said one or more light units includes an adhesive thereon.

4) The adjustable light strip of claim 3, wherein said adhesive is covered by a removable backing.

5) The adjustable light strip of claim 1, further comprising a magnetically operated momentary switch on said control unit and a magnet that is removably engageable with said momentary switch, wherein engagement of said magnet with said momentary switch prevents said one or more light units from illuminating, and wherein disengagement of said magnet with said momentary switch allows aid one or more light units to be illuminated.

6) The adjustable light strip of claim 1, wherein said one or more light units are adapted to be removed via a break away connection.
